(19) United States
(12) Patent Application Publication
(10) Pub. No.: US 2025/0283730 A1
(43) Pub. Date: Sep. 11, 2025

(54) CONTROL DEVICE, CONTROL METHOD, AND STORAGE MEDIUM

(71) Applicant: HONDA MOTOR CO., LTD., Tokyo (JP)

(72) Inventor: Tomotaka Teramachi, Tokyo (JP)

(21) Appl. No.: 19/059,625

(22) Filed: Feb. 21, 2025

(30) Foreign Application Priority Data
Mar. 11, 2024 (JP) 2024-037243

(51) Int. Cl. G01C 21/36; B60W 30/18; G06T 5/50; G06V 20/56

(52) U.S. Cl. CPC G01C 21/3667; B60W 30/18163; G06T 5/50; G06V 20/588; G06T 2207/20221

(57) ABSTRACT

A control device causes a display to display a lane; causes the display to display, in a case in which a target route is on a side of a lane adjacent to a first lane, an image in which an image of an object of movement display showing movement of the moving body to the lane side is superimposed on an image of an object of the adjacent lane; and causes the display to display, in a case in which the adjacent lane is a second lane connected to the first lane and widening ahead of a location, an image of an object of the second lane even in a case in which the second lane has not been recognized when the display is caused to display an image of an object of the movement display.

### CROSS-REFERENCE TO RELATED APPLICATION

Priority is claimed on Japanese Patent Application No. 2024-037243, filed Mar. 11, 2024, the content of which is incorporated herein by reference.

### BACKGROUND

### Field of the Invention

The present invention relates to a control device, a control method, and a storage medium.

### Description of Related Art

In recent years, efforts to provide sustainable transportation systems taking various situations into account have become active. In order to realize this, efforts are focused on research and development for further improvement in traffic safety and convenience through research and development related to driving assistance technologies. A display control device displaying first contents for guiding a lane change when it is judged to recommend a lane change on the basis of route information and displaying second contents for guiding a driving operation, which is recommended after a lane change, before display of the first contents ends has been disclosed (Japanese Unexamined Patent Application, First Publication No. 2021-094965).

### SUMMARY

In the technologies in the related art, there were cases in which a display could not display information corresponding to control of a moving body, resulting in poor user convenience. For example, when there is no road, a lane change destination road cannot be displayed so that the timing of displaying guidance on a lane change may be delayed or guidance display to a location where there is no road may be displayed, and this may cause discomfort to a user. Accordingly, user convenience may deteriorate.

The present invention has been made in consideration of such circumstances, and an object thereof is to provide a control device, a control method, and a storage medium in which convenience of an occupant (for example, a driver) of a moving body can be improved. This will ultimately contribute to development of sustainable transportation systems. Specifically, it is possible to display guidance display at an appropriate timing. Moreover, it is possible to perform display causing no discomfort.

A control device, a control method, and a storage medium according to this invention employ the following constitutions.

(1): A control device according to an aspect of this invention includes a storage medium storing computer-readable instructions, and at least one processor connected to the storage medium. The processor executes the computer-readable instructions to: recognize a situation around a moving body; cause a display to display a lane included in the recognized surrounding situation; cause the display to display, in a case in which a target route of the moving body is on a side of a lane adjacent to a first lane where the moving body is traveling, an image in which an image of an object of movement display showing movement of the moving body to the lane side is superimposed on an image of an object of the adjacent lane; and cause the display to display, in a case in which the adjacent lane is a second lane connected to the first lane and widening ahead of a location where the moving body is traveling in a proceeding direction of the moving body, an image of an object of the second lane even in a case in which a recognizer has not recognized the second lane when the display is caused to display an image of an object of the movement display.

(2): According to the aspect of the foregoing (1), the processor executes the computer-readable instructions to: identify that the second lane is present in the proceeding direction of the moving body on the basis of road information and cause the display to display an image of an object of the second lane.

(3): According to the aspect of the foregoing (1), the processor executes the computer-readable instructions to: cause the display to display an image of an object of the second lane and an image of an object of the movement display at the same time.

(4): According to the aspect of the foregoing (1), the processor executes the computer-readable instructions to: cause the display to display an image of an object of the movement display after the display is caused to display an image of an object of the second lane.

(5): According to the aspect of the foregoing (1), the processor executes the computer-readable instructions to: execute auto lane change control of causing the moving body to automatically perform a lane change to the second lane; and cause the display to display an image of an object of the second lane and an image of an object of the movement display in a superimposed manner in a case in which the auto lane change control is executed.

(6): According to the aspect of the foregoing (1), the processor executes the computer-readable instructions to: cause the display to display an image including a first image of an object of the moving body, a second image of an object of the second lane, and a third image of an object of the movement display associated with the first image and the second image in a case in which the moving body is scheduled to perform a lane change to the second lane and an occupant of the moving body is notified of the lane change to the second lane even in a case in which the second lane is unrecognizable because the moving body is present at a predetermined distance before a starting point of the second lane.

(7): According to the aspect of the foregoing (6), the processor executes the computer-readable instructions to: cause the display to display an image of an object of the recognized lane; and cause the display to display an image of an object of the movement display indicating that the moving body will move to the second lane after the display is caused to display an image of an object of the second lane on the basis of information indicating that the second lane acquired from a navigation device is present, even in a case in which the second lane is not included in a recognized lane when the moving body has arrived at a location a first distance from the second lane in a case in which an occupant of the moving body is issuing an instruction to cause the moving body to automatically perform a lane change or cause the display to display an image of an object of the movement display at a timing when an image of an object of the second lane is displayed, even in a case in which the second lane is not included in a recognized lane when the moving body has arrived at a location a first distance from the second lane in a case in which an occupant of the moving body is issuing an instruction to cause the moving body to automatically perform a lane change.

(8): A control method according to another aspect of the present invention causes a computer to execute processing of recognizing a situation around a moving body; processing of causing a display to display a lane included in the surrounding situation; processing of causing the display to display, in a case in which a target route of the moving body is on a side of a lane adjacent to a first lane where the moving body is traveling, an image in which an image of an object of movement display showing movement of the moving body to the lane side is superimposed on an image of an object of the adjacent lane; and processing of causing the display to display, in a case in which the adjacent lane is a second lane connected to the first lane and widening ahead of a location where the moving body is traveling in a proceeding direction of the moving body, an image of an object of the second lane even in a case in which the second lane has not been recognized in the recognizing processing when the display is caused to display an image of an object of the movement display.

(9): A storage medium storing a program according to another aspect of the present invention is a storage medium causing a computer to execute processing of recognizing a situation around a moving body; processing of causing a display to display a lane included in the surrounding situation; processing of causing the display to display, in a case in which a target route of the moving body is on a side of a lane adjacent to a first lane where the moving body is traveling, an image in which an image of an object of movement display showing movement of the moving body to the lane side is superimposed on an image of an object of the adjacent lane; and processing of causing the display to display, in a case in which the adjacent lane is a second lane connected to the first lane and widening ahead of a location where the moving body is traveling in a proceeding direction of the moving body, an image of an object of the second lane even in a case in which the second lane has not been recognized in the recognizing processing when the display is caused to display an image of an object of the movement display.

According to the aspects of the foregoing (1) to (9), it is possible to improve user convenience. Since an image of an object of the second lane is displayed in accordance with the timing when an image of an object of the movement display is displayed, it is possible to curb discomfort to an occupant caused by having no image of an object of a movement destination lane displayed although an image of an object of the movement display is being displayed.

According to the aspect of (2), it is possible to more reliably display an image of an object of the second lane on the basis of road information.

According to the aspect of (3), since an image of an object of the movement display and an image of an object of the second lane are displayed at the same time in a linked manner, it is possible to more reliably curb discomfort to an occupant. For example, it is possible to curb display of only an image of an object of the second lane or only an image of an object of the movement display.

According to the aspect of (4), since an image of an object of the movement display is displayed after an image of an object of the second lane is displayed, discomfort to an occupant is further reduced.

According to the aspect of (5), in a case in which a lane change is performed automatically, since display of an image of an object of the movement display in a direction in which the second lane is not present is curbed, a lane change is performed automatically in a state in which an occupant is at ease.

According to the aspect of (6), in a case in which a vehicle performs a lane change, it is possible to provide appropriate information to an occupant in accordance with change in location of the vehicle.

### BRIEF DESCRIPTION OF THE DRAWINGS

FIG. 1 is a view of the constitution of a vehicle system utilizing a vehicle control system according to an embodiment.

FIG. 2 is an explanatory view of a comparative example (part 1).

FIG. 3 is an explanatory view of another comparative example (part 2).

FIG. 4 is an explanatory view of an image displayed in a display of the embodiment.

FIG. 5 is a flowchart showing an example of a flow of processing executed by a driving assistance device.

### DETAILED DESCRIPTION OF THE INVENTION

### [Overall Constitution]

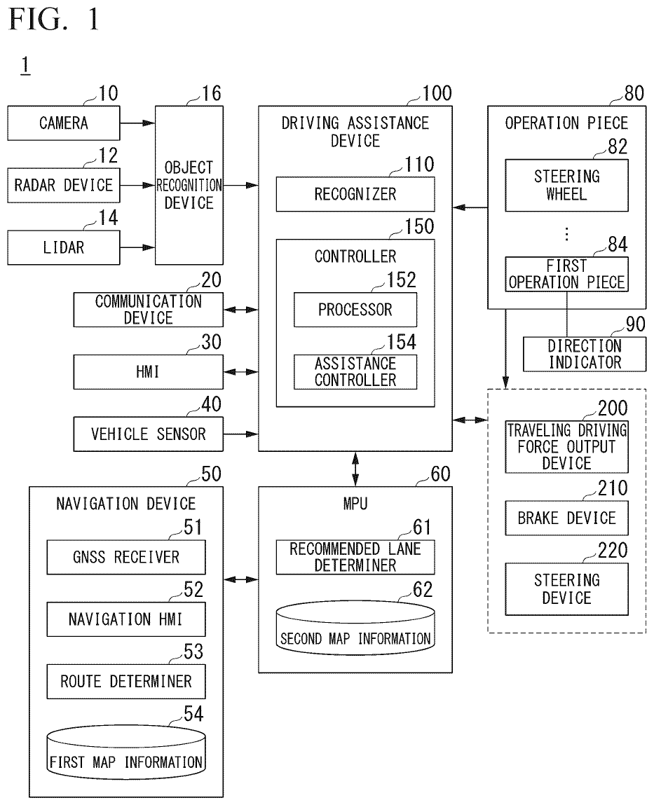

FIG. 1 is a view of the constitution of a vehicle system 1 utilizing a vehicle control system according to an embodiment. For example, a vehicle having the vehicle system 1 mounted therein is a vehicle having two wheels, three wheels, four wheels, or the like, and a drive source thereof is an internal-combustion engine such as a diesel engine or a gasoline engine, an electric motor, or a combination of these. An electric motor is operated using power generated by a generator connected to an internal-combustion engine, or discharge power of a secondary battery or a fuel cell. The present embodiment will be described as being applied to vehicles but may also be applied to other moving bodies instead of vehicles.

For example, the vehicle system 1 includes a camera 10, a radar device 12, a light detection and ranging (LIDAR) 14, an object recognition device 16, a communication device 20, a human machine interface (HMI) 30, a vehicle sensor 40, a navigation device 50, an MPU 60, an operation piece 80, a direction indicator 90, a driving assistance device 100, a traveling driving force output device 200, a brake device 210, and a steering device 220. These devices and instruments are connected to each other through multiplex communication lines such as controller area network (CAN) communication lines, serial communication lines, a wireless communication network, or the like. The constituents shown in FIG. 1 are merely an example. Some of the constituents may be omitted, and other constituents may further be added thereto. The driving assistance device 100 is an example of “a control device”.

For example, the camera 10 is a digital camera utilizing a solid-state image capturing element such as a charge coupled device (CCD) or a complementary metal oxide semiconductor (CMOS). The camera 10 is attached to an arbitrary location in the vehicle having the vehicle system 1 mounted therein (hereinafter, the vehicle M). When images on the side in front are captured, the camera 10 is attached to an upper part of a front windshield, a rear surface of a rearview mirror, or the like. For example, the camera 10 captures images around the vehicle M periodically and repeatedly. The camera 10 may be a stereo camera.

The radar device 12 radiates radio waves such as millimeter waves around the vehicle M and detects at least the location (distance and azimuth) of an object by detecting radio waves (reflected waves) reflected by the object. The radar device 12 is attached to an arbitrary location in the vehicle M. The radar device 12 may detect the location and the speed of an object by a frequency modulated continuous wave (FM-CW) method.

The LIDAR 14 emits light (or electromagnetic waves having wavelengths close to that of light) around the vehicle M and measures scattered light. The LIDAR 14 detects the distance to a target on the basis of the time from light emission to light reception. For example, emitted light is pulsed laser light. The LIDAR 14 is attached to an arbitrary location in the vehicle M.

The object recognition device 16 recognizes the location, the kind, the speed, and the like of an object by performing sensor fusion processing with respect to detection results of some or all of the camera 10, the radar device 12, and the LIDAR 14. The object recognition device 16 outputs recognition results to the driving assistance device 100. The object recognition device 16 may output the detection results of the camera 10, the radar device 12, and the LIDAR 14 to the driving assistance device 100 without any change. The object recognition device 16 may be omitted from the vehicle system 1.

For example, the communication device 20 communicates with other vehicles present around the vehicle M utilizing a cellular network, a Wi-Fi network, Bluetooth (registered trademark), dedicated short range communication (DSRC), or the like or communicates with various server devices via a wireless base station.

The HMI 30 provides various information to an occupant of the vehicle M and receives an input operation of the occupant. The HMI 30 includes various display devices, a speaker, a buzzer, a touch panel, a switch, a key, and the like. The HMI 30 includes a display device. For example, the display device is a display device (so-called multi-information display) provided in a central part of an instrument panel of the vehicle M and displaying various information in the vehicle M, such as a speedometer showing the traveling speed of the vehicle M and a tachometer showing a rotation frequency (rotational speed) of the internal-combustion engine provided in the vehicle M.

The vehicle sensor 40 includes a vehicle speed sensor for detecting the speed of the vehicle M, an acceleration sensor for detecting an acceleration, a yaw rate sensor for detecting an angular velocity around a vertical axis, an azimuth sensor for detecting a direction of the vehicle M, and the like.

For example, the navigation device 50 includes a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 identifies the location of the vehicle M on the basis of a signal received from a GNSS satellite. The location of the vehicle M may be identified or completed by an inertial navigation system (INS) utilizing an output of the vehicle sensor 40. The navigation HMI 52 includes a display device, a speaker, a touch panel, a key, and the like. Some or all of the navigation HMI 52 may be shared by the HMI 30 described above. For example, the route determiner 53 determines, with reference to the first map information 54, a route from the location of the vehicle M identified by the GNSS receiver 51 (or an arbitrary input location) to a destination input by an occupant (hereinafter, a route on the map) using the navigation HMI 52. For example, the first map information 54 is information in which road shapes are expressed by links indicating roads and nodes connected by the links. The first map information 54 may include curvatures of roads, point-of-interest (POI) information, and the like. The route on the map is output to the MPU 60. The navigation device 50 may perform route guidance using the navigation HMI 52 on the basis of the route on the map. For example, the navigation device 50 may be realized by a function of a terminal device such as a smartphone or a tablet terminal possessed by an occupant. The navigation device 50 may transmit a current location and a destination to a navigation server via the communication device 20 and acquire a route equivalent to the route on the map from the navigation server.

For example, the MPU 60 includes a recommended lane determiner 61 and retains second map information 62 in a storage device such as an HDD or a flash memory. The recommended lane determiner 61 divides the route on the map provided from the navigation device 50 into a plurality of blocks (for example, divides it into blocks of 100 [m] in a vehicle proceeding direction) and determines a recommended lane for each block with reference to the second map information 62. The recommended lane determiner 61 determines in which lane from the left the vehicle should travel. When a branching point is present in the route on the map, the recommended lane determiner 61 determines a recommended lane such that the vehicle M can travel along a reasonable route to proceed to a branch destination. For example, when the vehicle M has arrived at a location a predetermined distance before a branch road to which it proceeds, the recommended lane determiner 61 determines a lane connected to the branch road as a recommended lane. The recommended lane determiner 61 and the second map information 62 may be a functioning part and information provided in other devices such as the driving assistance device 100.

The second map information 62 is map information that is more accurate than the first map information 54. For example, the second map information 62 includes information of the center of a lane, information of the boundary of a lane, and the like. The second map information 62 may include road information, traffic regulation information, address information (address, postal code), facility information, telephone number information, and the like. The second map information 62 may be updated at any time by the communication device 20 through communication with other devices.

For example, the operation piece 80 includes a steering wheel 82 as well as an accelerator pedal, a brake pedal, a shift lever, and other operation pieces. A sensor for detecting an amount of operation or whether there is an operation is attached to the operation piece 80, and detection results thereof are output to some or all of the driving assistance device 100, the traveling driving force output device 200, the brake device 210, and the steering device 220. The steering wheel 82 does not necessarily have an annular shape and may be in a form of a deformed steering wheel, a joystick, a button, or the like. The operation piece 80 includes a first operation piece 84. The direction indicator 90 is turned on or turned off in response to an operation of the first operation piece 84.

For example, the first operation piece 84 is a turn signal lever switch. For example, if a driver operates the first operation piece 84, the direction indicator 90 is turned on in response to the operation. If a driver performs a predetermined operation with respect to the first operation piece 84, a controller 150 starts up an auto lane change (ALC) function to cause the vehicle M to perform an auto lane change. A predetermined operation is an operation that becomes a trigger for starting up the ALC function. For example, a predetermined operation includes an operation of the turn signal lever switch performed for a predetermined period of time in a direction in which a driver desires to perform a lane change, and an operation of pushing the turn signal lever switch to a predetermined location. More specifically, a predetermined operation includes an operation of the turn signal lever switch performed for a predetermined period of time in a direction in which a driver desires to perform a lane change in state in which a predetermined location is maintained. The first operation piece 84 may be in a different form, such as a button, in place of a turn signal lever switch. The ALC function may be started up in response to an operation with respect to a different operation piece, such as a predetermined button.

For example, the driving assistance device 100 includes a recognizer 110 and the controller 150. For example, the recognizer 110 and the controller 150 are realized by a hardware processor such as a central processing unit (CPU) executing a program (software). Some or all of these constituent elements may be realized by hardware (circuit; including circuitry), such as a large-scale integration (LSI), an application specific integrated circuit (ASIC), a field-programmable gate array (FPGA), a graphics processing unit (GPU), or system on chip (SOC), or may be realized by software and hardware in cooperation. A program may be stored in a storage device such as an HDD or a flash memory (a storage device including a non-transitory storage medium) of the driving assistance device 100 in advance or may be stored in an attachable/detachable storage medium such as a DVD or a CD-ROM such that the program is installed in the HDD or the flash memory of the driving assistance device 100 when the storage medium (non-transitory storage medium) is mounted in a drive device.

The recognizer 110 recognizes states of the location, the speed, the acceleration, and the like of an object around the vehicle M on the basis of information input from the camera 10, the radar device 12, and the LIDAR 14 via the object recognition device 16. For example, the location of an object is recognized as a location on absolute coordinates with an origin at a representative point (centroid, drive shaft center, or the like) in the vehicle M and is used for control. The location of an object may be indicated by a representative point such as a centroid or a corner of the object or may be indicated as a region. A “state” of an object may include an acceleration or a jerk of the object or “an action state” (for example, whether or not it is performing a lane change or attempting a lane change).

For example, the recognizer 110 recognizes a lane in which the vehicle M is traveling (traveling lane). For example, the recognizer 110 recognizes a traveling lane by comparing the pattern of a road division line (for example, an array of solid lines and dashed line) obtained from the second map information 62 with the pattern of the road division line around the vehicle M recognized from images captured by the camera 10. The recognizer 110 may recognize a traveling lane by recognizing traveling path boundaries (road boundaries) including road division lines, road shoulders, curbstones, median strips, guardrails, and the like without being limited to road division lines. In this recognition, the location of the vehicle M acquired from the navigation device 50 or processing results of the INS may be added. The recognizer 110 recognizes stop lines, obstacles, red lights, toll gates, and other road events.

When recognizing a traveling lane, the recognizer 110 recognizes the location and the posture of the vehicle M with respect to the traveling lane. For example, the recognizer 110 may recognize a deviation of a reference point in the vehicle M from the center of the lane and an angle formed with respect to a line of the centers of the lane of the vehicle M in the proceeding direction as the relative location and a posture of the host vehicle M with respect to the traveling lane. Instead of this, the recognizer 110 may recognize a location or the like of a reference point in the vehicle M with respect to any side end part (road division line or road boundary) of the traveling lane as the relative location of the vehicle M with respect to the traveling lane.

The controller 150 executes driving assistance control. For example, the controller 150 automatically controls the speed of the vehicle M by automatically controlling the traveling driving force output device 200 and the brake device 210 without relying on a driver's operation. The controller 150 executes so-called adaptive cruise control (ACC). The controller 150 controls the vehicle M to travel at a set speed or to follow a preceding vehicle at a location a predetermined distance away from the preceding vehicle.

The controller 150 controls the steering device 220 such that the vehicle M does not deviate from the traveling lane. For example, the controller 150 controls the steering device 220 such that the vehicle M travels in the center or near the center of the traveling lane recognized by the recognizer 110. Hereinafter, this control may be referred to as “lane keeping control”. The controller 150 executes hands-on lane keeping control and hands-off lane keeping control.

The hands-on lane keeping control is control executed in a state in which a driver is gripping the steering wheel (a state in which a steering gripping sensor (not shown) has detected gripping of the steering wheel). The conditions under which the hands-on lane keeping control can be executed are less strict than the conditions under which the hands-off lane keeping control can be executed.

The hands-off lane keeping control is control executed in a state in which a driver is not gripping the steering wheel (a state in which the steering gripping sensor (not shown) has not detected gripping of the steering wheel). For example, the hands-off lane keeping control can be executed when the following conditions are satisfied: the speed of the vehicle M is equal to or higher than a predetermined speed, the vehicle M is traveling on a predetermined road (for example, a road or a type of a road that has been set in advance such that the hands-off lane keeping control can be executed), and a driver is monitoring ahead. The hands-off lane keeping control is executed when the driver is monitoring ahead, and the hands-off lane keeping control is not executed or stops when the driver is not monitoring ahead.

The conditions under which the hands-on lane keeping control and the hands-off lane keeping control can be executed are examples, and other conditions (for example, the vehicle M is following a preceding vehicle) may be included or some conditions may be omitted. The conditions under which the hands-on lane keeping control can be executed need only be less strict than the conditions under which the hands-off lane keeping control can be executed (the conditions under which the hands-off lane keeping control can be executed need only be stricter than the conditions under which the hands-on lane keeping control can be executed). The driving assistance device 100 recognizes whether a driver is monitoring ahead on the basis of images captured by the camera (not shown) capturing images of the driver.

The controller 150 includes a processor 152 and an assistance controller 154 (lane change controller). The controller 150 causes the vehicle M to automatically perform a lane change. Details of these will be described below. An automatically performed lane change may be controlled on condition that the hands-off lane keeping control is executed or the hands-on lane keeping control is executed.

The traveling driving force output device 200 outputs a traveling driving force (torque) for causing the vehicle M to travel to driving wheels. For example, the traveling driving force output device 200 includes a combination of an internal-combustion engine, an electric motor, a transmission, and the like, and an ECU controlling these. The ECU controls the foregoing constituents in accordance with information input from the driving assistance device 100 or information input from the operation piece 80.

For example, the brake device 210 includes a brake caliper, a cylinder transmitting a hydraulic pressure to the brake caliper, an electric motor generating a hydraulic pressure in the cylinder, and a brake ECU. The brake ECU controls the electric motor in accordance with information input from the driving assistance device 100 or information input from the operation piece 80 such that a brake torque corresponding to a braking operation is output to each of the wheels.

For example, the steering device 220 includes a steering ECU and an electric motor. For example, the electric motor causes a force to act on a rack-and-pinion mechanism to change the direction of steered wheels. The steering ECU drives the electric motor in accordance with information input from the driving assistance device 100 or information input from the operation piece 80 to change the direction of the steered wheels.

### Comparative Example

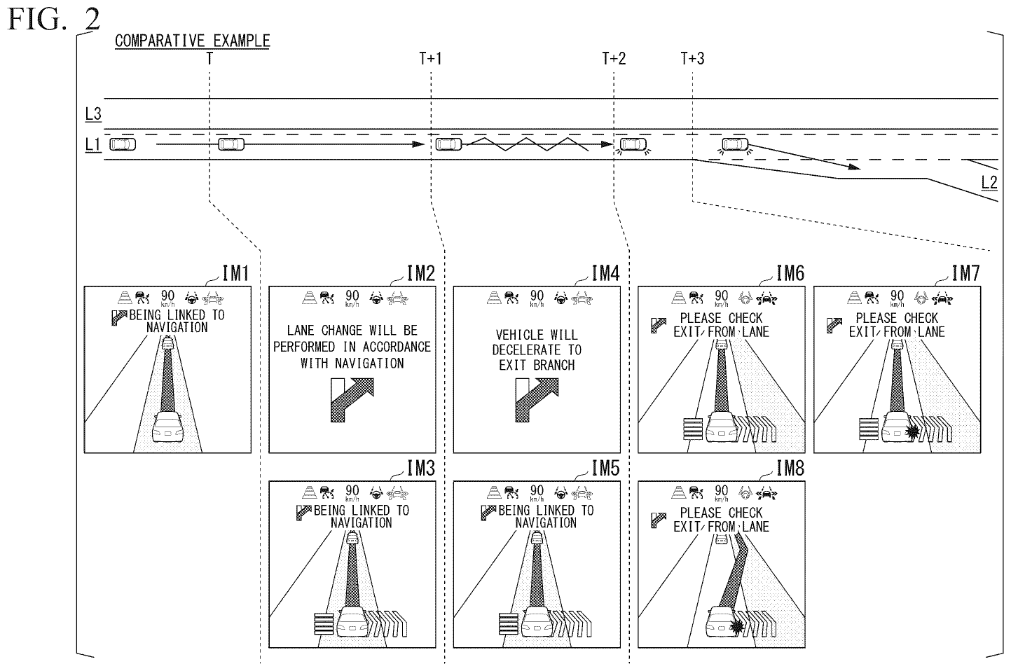

FIG. 2 is an explanatory view of a comparative example (part 1). For example, the vehicle M is traveling in a first lane L1. The vehicle M is scheduled to perform a lane change to a second lane L2 adjacent to the first lane L1. The second lane L2 is a branch lane branching from the first lane L1. For example, the following control is control executed when a target route is set for the vehicle M traveling in the second lane L2. The control is executed when an occupant (driver) of the vehicle M performs an operation of instructing the vehicle M to perform a lane change to the second lane L2 a predetermined distance before a connection location where the first lane L1 and the second lane L2 are connected. For example, an instructing operation is any operation such as an operation of a reservation button for a predetermined lane change or an operation of the first operation piece 84. For example, branching assistance control in which a lane change to a branch lane is performed automatically by operating the reservation button is executed.

For example, when approaching a branch lane, the assistance controller 154 automatically performs deceleration, turns on the direction indicator 90 at an appropriate timing, and automatically controls steering without relying on a driver's operation to cause the vehicle M to perform a lane change to the branch lane. For example, this assistance control may be performed when the hands-off lane keeping control or the hands-on lane keeping control is executed.

The processor 152 causes a display of the HMI 30 to display the lane included in recognition results of the recognizer 110 (for example, images captured by the camera 10). For example, the display is a display provided at a location which is easy for a driver to visually recognize. For example, the processor 152 converts the environment, objects, and the like around the vehicle M, such as lanes and preceding vehicles, recognized by the recognizer 110 into images and causes the display to display the images of the environment, the objects, and the like after conversion. For example, the display is a meter display, the multi-information display, a display provided at a location which is easy for a driver to visually recognize, and the like of the HMI 30.

A time T is a timing when the vehicle M has arrived at a location a first predetermined distance before a connection location (a location at a time T+3). A time T+1 is a timing when the vehicle M has arrived at a location a second predetermined distance before the connection location. The second predetermined distance is a distance shorter than the first predetermined distance. A time T+2 is a timing when the vehicle M has arrived at a location a third predetermined distance before the connection location. The third predetermined distance is a distance shorter than the second predetermined distance. At the time T+2, the direction indicator 90 is turned on. The time T+3 is a timing when a lane change to the second lane L2 starts (or a timing immediately before it starts).

The period from the time T to the time T+1 is a section during which the driving assistance device 100 starts inducing the vehicle M to perform a lane change to a lane change destination. The period from the time T+1 to the time T+2 is a section during which the driving assistance device 100 decelerates the vehicle M in advance to perform a lane change to the branch road.

Before the time T, the display displays an image IM1. During the period from the time T to the time T+1, the display displays an image IM2 and thereafter displays an image IM3. During the period from the time T+1 to the time T+2, the display displays an image IM4 and an image IM5 in this order. After the time T+2, the display displays an image IM6, an image IM7, and an image IM8 in this order.

The vehicle included in the image is an example of an image of an object of the vehicle M. The lane in which the vehicle included in the image is traveling is an example of an image of an object of the first lane L1. The lane adjacent to the lane in which the vehicle included in the image is traveling (the lane adjacent to the right side) is an example of an image of an object of the second lane L2. The arrow extending from the vehicle included in the image IM3 (an image IM3 # which will be described below) or the image IM5 (an image IM5 # which will be described below) is an example of an image of an object of movement display.

The image IM1 includes information indicating the first lane L1 and a third lane L3 recognized by the recognizer 110, the vehicle M (the vehicle at the bottom in the image), and a future trajectory of the vehicle M. The third lane L3 is a lane adjacent to the first lane L1. When the image IM1 is being displayed, it is linked to navigation. Being linked to navigation denotes that the processor 152 causes the display to display an image utilizing information of the navigation device 50 or an image can be displayed in the display.

The image IM2 is an image displayed utilizing a link to navigation. The same applies to images IM3 to IM10 which will be described below. When the processor 152 receives that the vehicle M is approaching the location of a lane change from the navigation device 50, the display is caused to display information indicating that the vehicle M will perform a lane change. For example, the image IM2 includes an arrow indicating the direction of a lane change. After the image IM2 is displayed, if the vehicle M approaches the connection location, the processor 152 causes the display to display the image IM3. The image IM3 is an image including information in which the information (arrow) indicating the direction in which the vehicle M performs a lane change is associated with the vehicle M in the image IM1.

The image IM4 includes the information indicating the direction in which the vehicle M performs a lane change and the information indicating that the vehicle M decelerates so that the vehicle M make exit to the branch lane. Accordingly, a driver can recognize deceleration of the vehicle M. The image IM5 is an image similar to the image IM3.

In addition to information of the image IM3 and the image IM5, the image IM6 includes an image of the second lane L2 recognized by the recognizer 110. Since the recognizer 110 has become able to recognize the second lane L2 as the vehicle M approaches the second lane L2, the display displays an image of the second lane L2.

The image IM7 is an image in which the direction indicator of the vehicle M in the image IM6 is turned on. The image IM8 is an image showing the trajectory of the vehicle M in the image IM7 proceeds from the first lane L1 to the second lane L2.

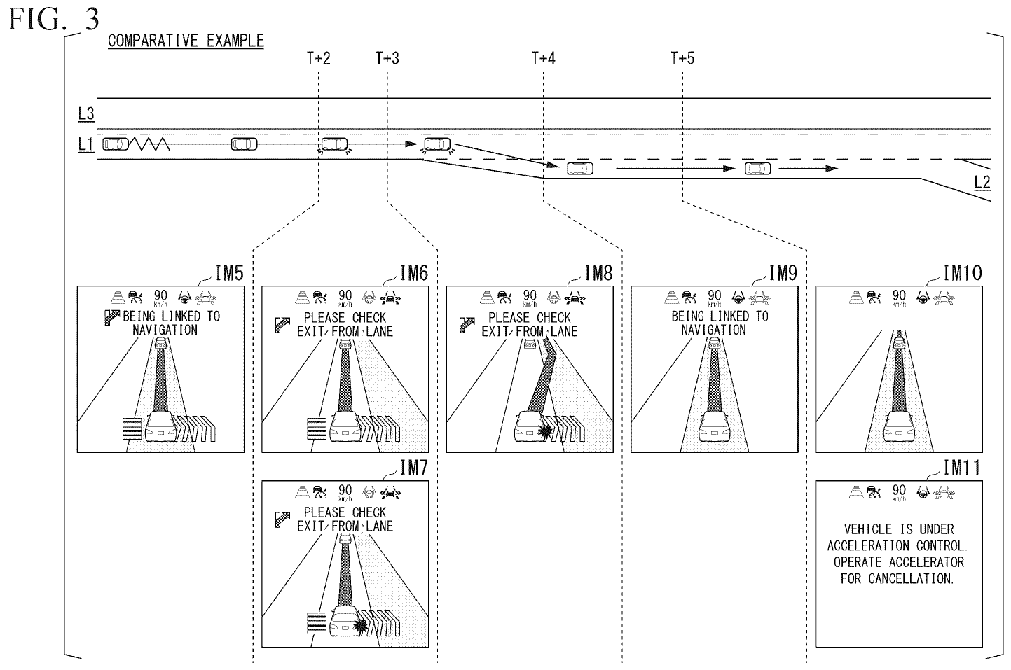

As described above, the periods until the time T+2 and after a time T+4 (which will be described below) are sections during which an occupant can selectively change the image displayed in the display. During the period from the time T+2 to the time T+4, an occupant can select and cause the display to display the contents shown in FIG. 2 or the contents different from the contents shown in FIG. 3 (the contents set in advance).

FIG. 3 is an explanatory view of another comparative example (part 2). FIG. 3 shows a scene after the time T+2 shown in FIG. 2. The image IM8 is displayed at the time T+3. At this time or thereafter, the vehicle M starts a lane change. At the time T+4, if the vehicle M performs a lane change and moves to the second lane L2, an image IM9 is displayed. The image IM9 is an image similar to the image IM1. At a time T+5, an image similar to the image IM9, or the image IM10 is displayed. The image IM10 is an image including the lane in which the vehicle M is traveling and a preceding vehicle. After the image IM10 is displayed, if the vehicle M approaches the location where the curvature of the second lane L2 increases, an image IM11 is displayed. The image IM11 shows information indicating that acceleration of the vehicle M is curbed in accordance with the curvature and information indicating that curbed acceleration can be canceled by an acceleration operation.

Here, in the image IM3 or the image IM5 described above, lateral movement display is displayed in a region in which no lane is present in the image. In this case, an occupant may feel discomfort. In contrast, in the present embodiment, discomfort to an occupant can be curbed by superimposing lateral movement display on the lane as below. Accordingly, it is possible to improve user convenience.

### [Display in Present Embodiment]

The processor 152 causes the display to display the lane included in the situation around the vehicle M recognized by the recognizer 110. When the target route of the vehicle M is on the lane side adjacent to the first lane in which the vehicle M is traveling, the processor 152 causes the display to display an image in which an image of an object of the movement display showing movement of the vehicle M to the lane side is superimposed on an image of an object of the adjacent lane.

The processor 152 causes the display to display, in a case in which the adjacent lane is the second lane connected to the first lane and widening ahead of the location where the vehicle M is traveling in the proceeding direction of the vehicle M, an image of an object of the second lane even in a case in which the recognizer 110 has not recognized the second lane when the display is caused to display an image of an object of the movement display.

For example, the processor 152 causes the display to display an image including an image of an object of the vehicle M, an image of an object of the second lane, and an image of an object of the movement display associated with the image of an object of the vehicle M and the image of an object of the second lane in a case in which the vehicle M is scheduled to perform a lane change to the second lane and an occupant of the vehicle M is notified of the lane change to the second lane even in a case in which the recognizer 110 cannot recognize the second lane because the vehicle M is present at a predetermined distance before a starting point of the second lane.

The processor 152 identifies that the second lane is present in the proceeding direction on the basis of road information and causes the display to display the second lane. For example, the road information is map information including information provided by the navigation device 50 and information related to roads stored in the storage or provided through communication (locational information of the branch road).

The processor 152 may cause the display to display an image of an object of the second lane and an image of an object of the movement display at the same time, or may cause the display to display an image of an object of the movement display after the display is caused to display an image of an object of the second lane.

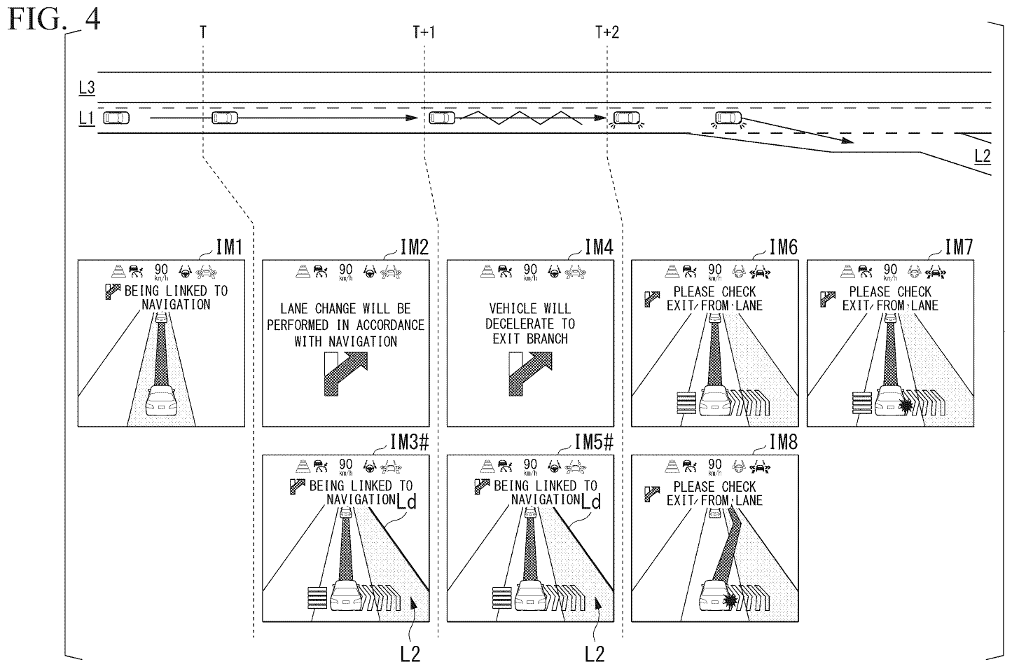

The processor 152 causes the display to display an image of an object of the movement display indicating that the vehicle M will move to the second lane after the display is caused to display an image of an object of the second lane on the basis of information indicating that the second lane acquired from the navigation device 50 is present, or causes the display to display an image of an object of the movement display at a timing when an image of an object of the second lane is displayed, even in a case in which the second lane is not included in a lane recognized by the recognizer 110 when the vehicle M has arrived at a location a first distance from the second lane in a case in which an occupant of the vehicle M is issuing an instruction to cause the assistance controller 154 to automatically perform a lane change. The expression “when the vehicle M has arrived at a location a first distance from the second lane” denotes a timing when the image IM3 # or the image IM5 # in FIG. 4 (which will be described below) is displayed.

FIG. 4 is an explanatory view of an image displayed in the display of the embodiment. A description similar to those of FIGS. 2 and 3 will be omitted. In the present embodiment, the image IM3 # is displayed in place of the image IM3, and the image IM5 # is displayed in place of the image IM5.

For example, in addition to the information of the image IM3, an image of an object of the second lane L2 and an image of an object of a road division line Ld in the second lane L2 are displayed in the image IM3 #. The image of the second lane L2 does not show the second lane L2 recognized by the recognizer 110 but is information acquired by the processor 152 linked to the navigation device 50 from the first map information 54 (or information acquired from the map information in the storage). Even when the recognizer 110 has not recognized the second lane L2, the processor 152 causes an image of the second lane L2 to be displayed on the basis of the timing when the movement display is displayed.

As described above, since the processor 152 causes the display to display the second lane L2, which has not been recognized by the recognizer 110, at an appropriate timing, display of the movement display in a region in which no lane is present in the image is curbed. Accordingly, discomfort to an occupant of the vehicle M is curbed so that convenience of the occupant of the vehicle M is improved.

For example, the foregoing processing may be executed when a driver of the vehicle manually performs a lane change or may be applied when the vehicle M automatically performs a lane change. For example, the processing of the present embodiment may be applied when the vehicle M automatically decelerates along a target route and turns on the direction indicator 90 and when auto lane change control in which the assistance controller 154 causes the vehicle M to automatically perform a lane change is executed. In this case, the processor 152 causes the display to display an image of an object of the second lane and an image of an object of the movement display in a superimposed manner when auto lane change control is executed. Accordingly, since display of an image of an object of the movement display in a direction in which the second lane is not present is curbed when a lane change is performed automatically, the sense of security of an occupant is improved.

### [Flowchart]

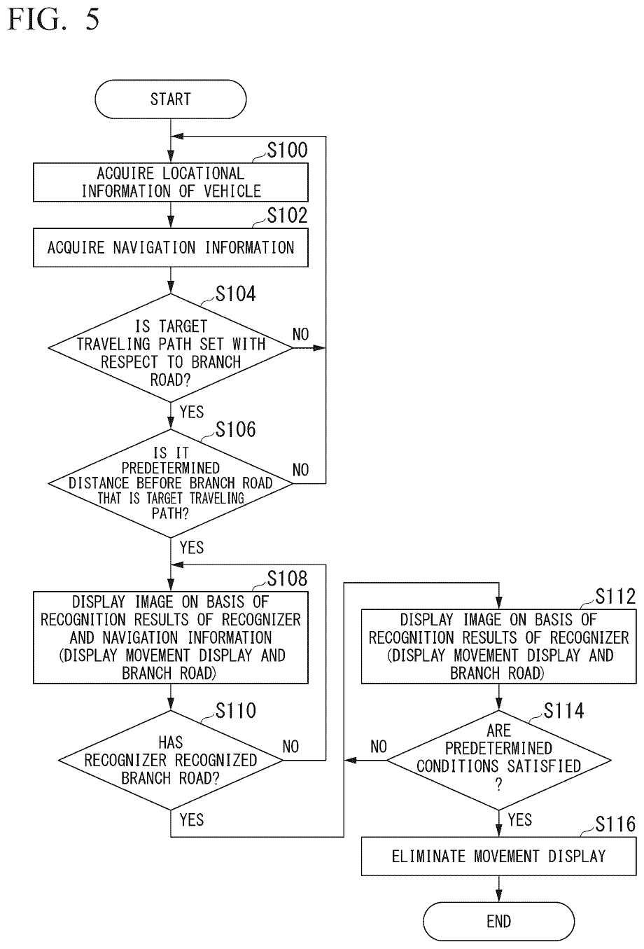

FIG. 5 is a flowchart showing an example of a flow of processing executed by the driving assistance device 100. First, the processor 152 acquires locational information of the vehicle M (Step S100). Next, the processor 152 acquires navigation information (Step S102). The navigation information includes information of a destination set in the navigation device 50, information of a target traveling path of the vehicle M guided by the navigation device 50, structures of roads around the target traveling path, and the like. The processing of Step S100 and Step S102 is repeatedly executed at predetermined intervals.

Next, the processor 152 judges whether or not a target traveling path is set for a branch road on the basis of the information acquired in Step S100 and S102 (Step S104). When no target traveling path is set for the branch road, the processing returns to Step S100. When a target traveling path is set for the branch road, the processor 152 judges whether or not the vehicle M has arrived at a location a predetermined distance before the branch road which is the target traveling path (Step S106). When the vehicle M has not arrived at the location a predetermined distance before the branch road which is the target traveling path, the processing returns to Step S100.

When the vehicle M has arrived at the location a predetermined distance before the branch road which is the target traveling path, the processor 152 causes the display to display an image corresponding to the location of the vehicle M with respect to the location of the branch road (Step S108). For example, the processor 152 causes images to be displayed as described in FIGS. 2 to 4. The processor 152 causes the display to display the movement display together with an image of the second lane L2 utilizing information of the branch road (branch lane) in the navigation information at the timing when the movement display is displayed.

Next, the processor 152 judges whether or not the recognizer 110 has recognized the branch road (Step S110). When the recognizer 110 has not recognized the branch road, the processing returns to Step S108. When the recognizer 110 has recognized the branch road, the processor 152 causes an image to be displayed on the basis of recognition results of the recognizer 110 (Step S112). For example, the processor 152 causes the display to display the movement display and information of the branch road included in the recognition results.

Next, the processor 152 judges whether or not predetermined conditions are satisfied (Step S114). The predetermined conditions include that the vehicle M has moved to the branch road (has moved to a location near the center of the branch road), that a lane change to the branch road has been completed, that the vehicle M has traveled a predetermined distance after it has moved to the branch road or after it has performed a lane change, and the like. When the predetermined conditions are not satisfied, the processing returns to Step S112. When the predetermined conditions are satisfied, the processor 152 eliminates the movement display (Step S116). Accordingly, the processing of one routine of this flowchart ends.

In place of the processing of the foregoing Step S110, it may be judged whether or not the conditions are satisfied. For example, the conditions are arbitrary conditions, such as the vehicle M having arrived at a predetermined location and the state of the vehicle M satisfying the conditions. For example, the state of the vehicle M satisfying the conditions denotes that arbitrary conditions, such as the predetermined conditions described above being satisfied and the direction indicator being turned off are satisfied.

As described above, the driving assistance device 100 can improve user convenience by displaying a branch road in accordance with movement display in an image utilizing navigation information.

According to the embodiment described above, the driving assistance device 100 can improve user convenience by causing the display to display, when a lane adjacent to the first lane is a second lane connected to the first lane and widening ahead of a location where the vehicle M is traveling in the proceeding direction of the vehicle M, an image of an object of the second lane even when the recognizer 110 has not recognized the second lane when the display is caused to display an image of an object of the movement display.

The embodiment described above can be expressed as follows.

A control device is constituted to include a storage device storing a program, and a hardware processor. The hardware processor executes the program stored in the storage device to: recognize a situation around a moving body; cause a display to display a lane included in the surrounding situation; cause the display to display, in a case in which a target route of the moving body is on a side of a lane adjacent to a first lane where the moving body is traveling, an image in which an image of an object of movement display showing movement of the moving body to the lane side is superimposed on an image of an object of the adjacent lane; and cause the display to display, in a case in which the adjacent lane is a second lane connected to the first lane and widening ahead of a location where the moving body is traveling in a proceeding direction of the moving body, an image of an object of the second lane even in a case in which a recognizer has not recognized the second lane when the display is caused to display an image of an object of the movement display.

Hereinabove, forms for performing the present invention have been described using an embodiment. However, the present invention is not limited to such an embodiment in any way, and various modifications and replacements can be added thereto within a range not departing from the gist of the present invention.

What is claimed is:

1. A control device comprising:
a storage medium storing computer-readable instructions; and
at least one processor connected to the storage medium,
wherein the processor executes the computer-readable instructions to:
recognize a situation around a moving body;
cause a display to display a lane included in the recognized surrounding situation;
cause the display to display, in a case in which a target route of the moving body is on a side of a lane adjacent to a first lane where the moving body is traveling, an image in which an image of an object of movement display showing movement of the moving body to the lane side is superimposed on an image of an object of the adjacent lane; and
cause the display to display, in a case in which the adjacent lane is a second lane connected to the first lane and widening ahead of a location where the moving body is traveling in a proceeding direction of the moving body, an image of an object of the second lane even in a case in which a recognizer has not recognized the second lane when the display is caused to display an image of an object of the movement display.

2. The control device according to claim 1,
wherein the processor executes the computer-readable instructions to: identify that the second lane is present in the proceeding direction of the moving body on the basis of road information and cause the display to display an image of an object of the second lane.

3. The control device according to claim 1,
wherein the processor executes the computer-readable instructions to: cause the display to display an image of an object of the second lane and an image of an object of the movement display at the same time.

4. The control device according to claim 1,
wherein the processor executes the computer-readable instructions to: cause the display to display an image of an object of the movement display after the display is caused to display an image of an object of the second lane.

5. The control device according to claim 1,
wherein the processor executes the computer-readable instructions to:
execute auto lane change control of causing the moving body to automatically perform a lane change to the second lane; and
cause the display to display an image of an object of the second lane and an image of an object of the movement display in a superimposed manner in a case in which the auto lane change control is executed.

6. The control device according to claim 1,
wherein the processor executes the computer-readable instructions to: cause the display to display an image including a first image of an object of the moving body, a second image of an object of the second lane, and a third image of an object of the movement display associated with the first image and the second image in a case in which the moving body is scheduled to perform a lane change to the second lane and an occupant of the moving body is notified of the lane change to the second lane even in a case in which the second lane is unrecognizable because the moving body is present at a predetermined distance before a starting point of the second lane.

7. The control device according to claim 6,
wherein the processor executes the computer-readable instructions to:
cause the display to display an image of an object of the recognized lane; and
cause the display to display an image of an object of the movement display indicating that the moving body will move to the second lane after the display is caused to display an image of an object of the second lane on the basis of information indicating that the second lane acquired from a navigation device is present, even in a case in which the second lane is not included in a recognized lane when the moving body has arrived at a location a first distance from the second lane in a case in which an occupant of the moving body is issuing an instruction to cause the moving body to automatically perform a lane change or
cause the display to display an image of an object of the movement display at a timing when an image of an object of the second lane is displayed, even in a case in which the second lane is not included in a recognized lane when the moving body has arrived at a location a first distance from the second lane in a case in which an occupant of the moving body is issuing an instruction to cause the moving body to automatically perform a lane change.

8. A control method for causing a computer to execute
processing of recognizing a situation around a moving body,
processing of causing a display to display a lane included in the surrounding situation,
processing of causing the display to display, in a case in which a target route of the moving body is on a side of a lane adjacent to a first lane where the moving body is traveling, an image in which an image of an object of movement display showing movement of the moving body to the lane side is superimposed on an image of an object of the adjacent lane, and
processing of causing the display to display, in a case in which the adjacent lane is a second lane connected to the first lane and widening ahead of a location where the moving body is traveling in a proceeding direction of the moving body, an image of an object of the second lane even in a case in which the second lane has not been recognized in the recognizing processing when the display is caused to display an image of an object of the movement display.

9. A storage medium storing a program for causing a computer to execute
processing of recognizing a situation around a moving body,
processing of causing a display to display a lane included in the surrounding situation,
processing of causing the display to display, in a case in which a target route of the moving body is on a side of a lane adjacent to a first lane where the moving body is traveling, an image in which an image of an object of movement display showing movement of the moving body to the lane side is superimposed on an image of an object of the adjacent lane, and
processing of causing the display to display, in a case in which the adjacent lane is a second lane connected to the first lane and widening ahead of a location where the moving body is traveling in a proceeding direction of the moving body, an image of an object of the second lane even in a case in which the second lane has not been recognized in the recognizing processing when the display is caused to display an image of an object of the movement display.
